(19) United States
(12) Patent Application Publication
(10) Pub. No.: US 2014/0317938 A1
(43) Pub. Date: Oct. 30, 2014

(54) Hair Bang Clipper

(71) Applicant: Fringe Cosmetics, LLC, Palm Beach Gardens, FL (US)

(72) Inventor: Melissa Peverini, Palm Beach Gardens, FL (US)

(73) Assignee: Fringe Cosmetics, LLC, Palm Beach Gardens, FL (US)

(21) Appl. No.: 14/268,600

(22) Filed: May 2, 2014

Related U.S. Application Data
(63) Continuation-in-part of application No. 12/715,143, filed on Mar. 1, 2010, now abandoned.
(60) Provisional application No. 61/156,235, filed on Feb. 27, 2009.

(51) Int. Cl. B26B 13/24; B26B 13/08

(52) U.S. Cl. CPC B26B 13/24; B26B 13/08
USPC 30/208; 30/244

(57) ABSTRACT

A hair clipper trimming device includes two arms that are pivotally connected along biasing members on each arm. The arms are biased to an open position by a spring mount. The opposite end of each arm includes cutting a surface. One cutting surface includes a row of teeth of alternating depth while the other cutting surface has a row of teeth of constant depth.

### CROSS REFERENCE TO RELATED APPLICATIONS

In accordance with 37 C.F.R. 1.76, a claim of priority is included in an Application Data Sheet filed concurrently herewith. Accordingly, the present invention claims priority as a continuation-in-part of U.S. patent application Ser. No. 12/715,143 filed Mar. 1, 2010 entitled “Hair Bang Clipper and Folding Comb” which claims the priority date of U.S. Provisional Application No. 61/156,235, entitled “Hair Bang Clipper and Folding Comb”, filed on Feb. 27, 2009 the contents of which are herein incorporated by reference.

### FIELD OF THE INVENTION

This invention is directed to the field of hair grooming and, more particularly to a device for clipping hair.

### BACKGROUND OF THE INVENTION

Cutting hair is a very popular and necessary profession. Professional stylists have countless techniques to provide different hair styles. However, a key to a satisfied customer is for the stylists to be consistent and reproduce a certain style of hair. This requires the hair stylist to follow a similar hair clipping technique for the customer over and over again. Unfortunately, the stylist may not remember the client's style, or may charge such a premium that frequent visits are not affordable to many clients. For this reason many people have tried to cut their own hair or rely upon friends to lessen if not eliminate the need for the stylist. Often the results are inconsistent and the hair style usually does not turn out how the customer had envisioned.

The trimming of hair can take many forms. Conventional hairstyling typically consists of dividing hair-bunches and cutting them at a constant angle to the scalp and at a constant length. When the hair-bunches are aligned to a constant shape, a consistent hairstyle can be created. A hairdresser may pull each hair-bunch up at an angle of about 90 degrees to the scalp, the hair-bunch is sandwiched between fingers of one hand and in this state, the hair-bunch is cut using a razor or scissors with the other hand.

A shaggy hair cut is carried out by dynamically shaping hair tips. To form this hairstyle it is necessary to cut the hair at a slant while carefully placing the lengths of the hair-bunches such that all the hair-bunches are formed into the same outline. Unless the person is skilled on precisely using scissors or a razor, this style haircut can be most difficult to obtain a favorable hairstyle. For this reason, conventional razor tools are usually used by a professional hairdresser at a beauty salon.

Different hair cutting devices are frequently used to cut hair at home, by oneself, or at a salon with an experienced hair stylist. These hair cutting accessories provide different methods to create a professional quality hair cut and attempt to allow for a reproducible and somewhat professional hairstyle. However, many of the hair cutting devices and guides still require a professional eye to correctly produce a straight cut, curved cut, tapered cut, or any other different type of cut or style that requires a certain technique.

What is lacking in the art is a hair trimming tool that is simple to operate, provide repeatability and professional results, and includes a cutting blade protector to eliminate injuries that commonly occur when scissors or a razor is employed.

### PRIOR ART REFERENCES

U.S. Pat. No. 1,853,828 discloses a comb guide to facilitate the proper cutting of the hair either by means of the mechanical hair clipper or scissors.

U.S. Pat. No. 4,428,119 discloses a pair of manually operated de-ending shears for removing split ends. The shears float like shears but cut like clippers. The device includes a moving blade slidably mounted to a still blade and handle wherein a moving handle is provided for moving the moving blade through a cutting stroke. A spring pocketed by the blades provides the means for a reverse clipping stroke.

U.S. Pat. No. 4,660,285 discloses thinning scissors, in which the cutting edge of at least one scissor blade is serrated and the cutting edge of the other scissor blade is smooth.

U.S. Pat. No. 5,012,830 discloses a method for facilitated precision cutting of hair by one handed sectioning, combing and locking of hair into position for cutting.

U.S. Pat. No. 5,107,591 discloses thinning scissors including a serrated blade wherein cutting teeth and non-cutting guides are spaced along the blade. The non-cutting guides will control the volume of hair to be cut in a thinning action.

U.S. Pat. No. 5,561,904 discloses a rose stem stripper having arms pivotally attached to each other at their bases.

U.S. Pat. No. 5,597,000 discloses a method and apparatus for styling hair includes a latch mechanism for releasably securing a hair styling device about the hair strands. The latch mechanism is adapted to interconnect first and second pivotally interconnected elongated members of the hair styling device and includes a first latch member disposed substantially adjacent a first end of the first elongated member and a second latch member disposed substantially adjacent first end of the second elongated member.

U.S. Pat. No. 6,883,239 discloses a hair-trimming device is disclosed. The device comprises a substantially U-shaped member having a first handle portion and a second handle portion and an elastic portion alloy the first handle portion and the second handle portion to elastically separated; a pair of razor-fastener connected to the ends of the first and second handle and one lateral edge of the razor fastener being longitudinally mounted with razor with protective cover; and a stop mounted across the first handle and the second handle such that the handles are restricted to open to an excessive scope.

U.S. Pat. No. 7,159,321 discloses a notched single-edge thinning scissors is disclosed to have chamfered edges formed in the notched blade between the hair contact side of the notched blade and the left sidewall, right sidewall and bottom wall of each notch, and between the cutting edges of the teeth of the notched blade and the left and right sidewalls of each notch for supporting the hair not to be cut during trimming.

U.S. Pat. No. 7,246,442 discloses a hair-trimming tool including a tool body having a pair of hair-bunch supporting pieces whose tip ends can open and close, a connecting portion which connects base ends of the hair-bunch supporting pieces, a protruding portion protruding from the connecting portion in a direction substantially perpendicular to an opening/closing direction of the hair-bunch supporting pieces, and a cutting element provided on at least one of the inner opposing surfaces of the hair-bunch supporting pieces along a longitudinal direction thereof.

U.S. Publication No. 2008/0060667 discloses a hair cutting device for facilitating and enhancing the ability to cut hair. The hair cutting device comprises a first elongated guide member that includes a first surface. The first surface includes a gravity field orientation sensor, to sense angular orientation.

### SUMMARY OF THE INVENTION

The instant invention is a hair clipper having a particular useful function in the clipping of bangs. The device allows an individual to clip their own bangs in a uniform or artistic manner without the need for use of conventional scissors or a razor as commonly employed. The clipper consists of a first and second arm each having a distal and proximal end. The first and second arms each include biasing members, which are connected together for rotation thereabout. The distal ends of each arm includes a cutting element that is positioned perpendicular to the length of the arm and in a parallel plane as the axis. When the first and second cutting elements are brought together they cooperate to clip hair in a unique chomping style operation. The use of a serrated edge on one of the cutting elements further bundles hair strands for ease of cutting.

The device includes hair alignment cover elements positioned over each arm and extending outward from the distal end of each arm. The hair alignment cover elements provide a cutting blade safety shield. The shield functions to prevent the cutting elements from use on any material other than hair.

Thus, an objective of the instant invention is to provide a unique trimming tool that allows an individual to trim their own fringe and bangs with no experience necessary to provide a look otherwise possible only by use of a hair stylist.

Another objective of the instant invention is to provide an ergonomic design, allows single hand operation, and eliminates the exposure of sharp points such as those found on scissors.

Yet another objective of the instant invention is to provide a safety feature that prevents the cutting elements from being exposed and limits the use of the device to trimming of hair.

Yet another objective of the instant invention is to provide serrated teeth or a textured blade on at least one cutting element to allow texture cuts typically found only with a professional hair stylist.

Yet another objective of the instant invention is to teach the use of an alignment element that is spaced apart from the cutting edge so as to prevent cutting hair too short.

Yet another objective of the instant invention is to provide a closing mechanism by use of a biasing member to provide a “chomp” or create a “one snip finish”.

Yet still another objective of the instant invention is to disclose the use of unique cutting blade designs that can be made from a variety of edges and shapes in order to create the most popular fringe styles.

Yet still another objective of the instant invention is to disclose a compact trimmer that allows for ease of storage and transport during travel.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 is an exploded view of the hair clipper;

FIG. 2 is an exploded view with hidden lines of the hair clipper;

FIG. 3 is a perspective view of the hair clipper; and

FIG. 4 is a side view of the hair clipper.

### DETAILED DESCRIPTION OF THE INVENTION

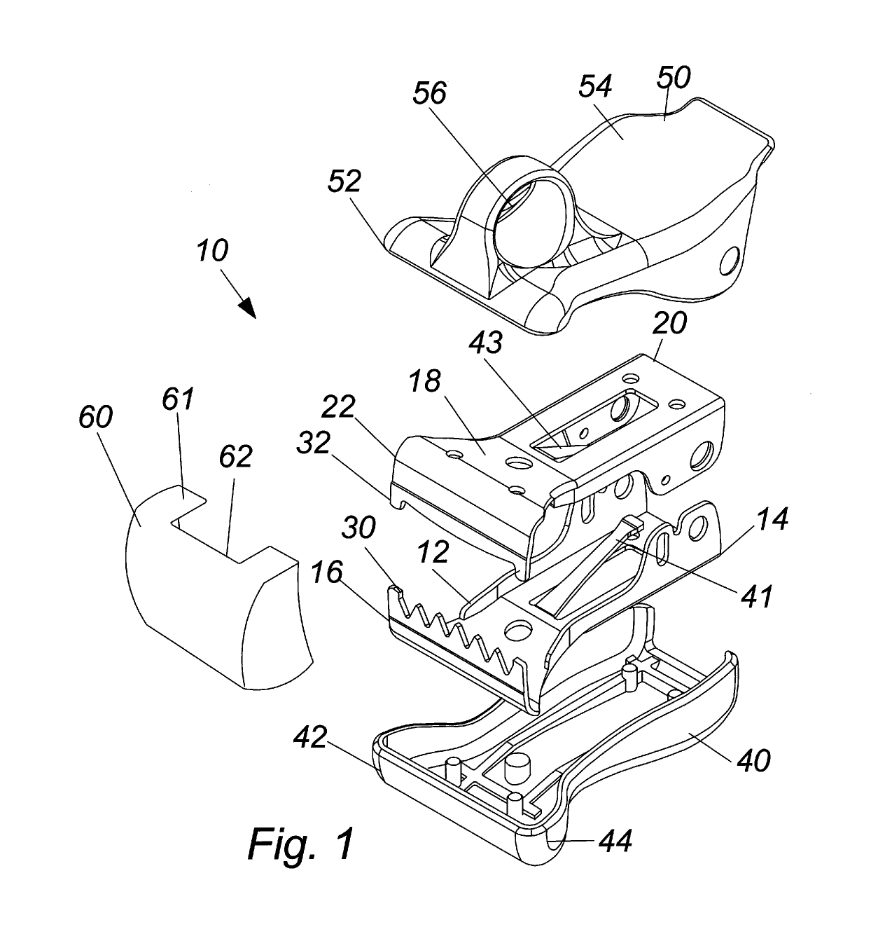

Now referring to FIGS. 1-4, the hair clipper (10) has a first arm (12) which has a proximal end (14) and a distal end (16), and a second arm (18) which has a proximal end (20) and a distal end (22). A first cutting element (30) is positioned along the distal end (16) of the first arm and a second cutting element (32) is positioned along the distal end (22) of the second arm. The first and second cutting elements (30 and 32) cooperate with each other to clip hair when the distal ends (16 and 22) are pivoted into a closed position.

A spring is incorporated between the first arm and second arm and may consist of a conventional spring or as shown in the instant embodiment having a biasing member (41) on the first arm (12) which cooperates with a biasing arm (43) located on the second arm (18) which maintain the distal ends (16 and 22) in an open position until physically closed for purposes of trimming the hair. The biasing arms (41 and 43) are pivotally connected together to allow rotation thereabout of each arm (12 and 18). The axis of rotation is defined by the connecting point of each biasing member (41 and 43).

A first alignment cover element (40) is positioned along the distal end of the first arm or can be used as a covering as depicted extending from the distal end (16) to the proximal end (14). In this embodiment the first hair alignment cover element (40) further provides an ornamental shape and gripping surface. It is important to note, the spacing between the distal end (42) of the first hair alignment cover element (40) being spaced apart from the distal end (16) of the first arm (12) so as to prevent excess cutting of the hair on an accidental basis. In addition, the side wall (44) of the distal end (42) provides a depth so as to encompass the cutting blade (30) of the first arm (12) preventing accidental injury by use as a safety guard.

A second hair alignment cover element (54) is depicted for placement over second arm (18) having a distal end (50) which is spaced apart from the distal end of the second arm (22) and provides a depth beyond cutting edge (32) further preventing injury to an individual who may accidentally attempt to stick an item such as a finger or other non hair items between the blades thereby preventing an individual placing their finger between the cutting blades or other non hair item. On the top surface (54) of the second hair alignment cover element is provided an ergonomic handle (56) whereby a user's finger can be placed within the handle to provide ease in positioning the hair clipper (10) in a closed position.

A cutting edge cover (60) is provided which is constructed and arranged to removably engage the first and second hair alignment cover elements (40 and 54) on the their distal ends (42 and 50). The cutting edge cover (60) includes a U-shaped channel (62) on the top surface (61) thereof that is constructed and arranged to snuggly encompass the ergonomical handle (56). The frictional relationship between the cover (60) and first and second hair alignment cover elements (40 and 54) allow the cover (60) to remain in place until a user removes it. The frictional relationship is furthered because the cover (60) is sized to fit overtop the first and second hair alignment cover elements (40 and 54) when in a closed positioned, whereby the biasing arms (41 and 43) want to force the first and second arm (12 and 18) into an open position thereby creating tension on the cover (60) top surface (61). The cover (60) provides safety by preventing injury to an individual who may accidentally attempt to stick an item such as a finger or other non hair items between the blades (30 and 32).

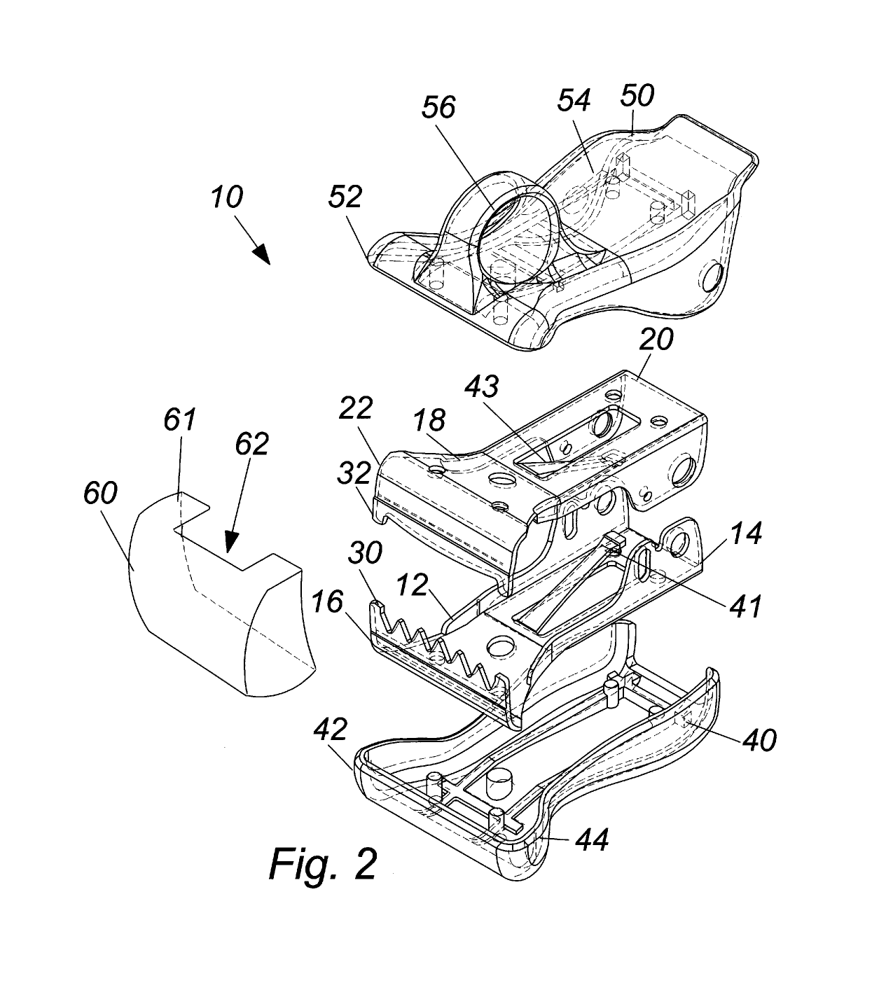

As shown in FIGS. 1 and 2, the hair clipper (10) is in an open position wherein the cutting blades (30 and 32) from the first arm and second arm respectively are in an open position as forced by biasing spring (41 and 43). It should also be noted that the spacing between the distal end of the first hair alignment element (42) and the distal end on the second hair alignment element (52) is spaced apart from the cutting element as previously described so as to prevent accidental cutting of the hair in too short of a manner. The preferred opening is approximately 1.5 centimeters in a relaxed state.

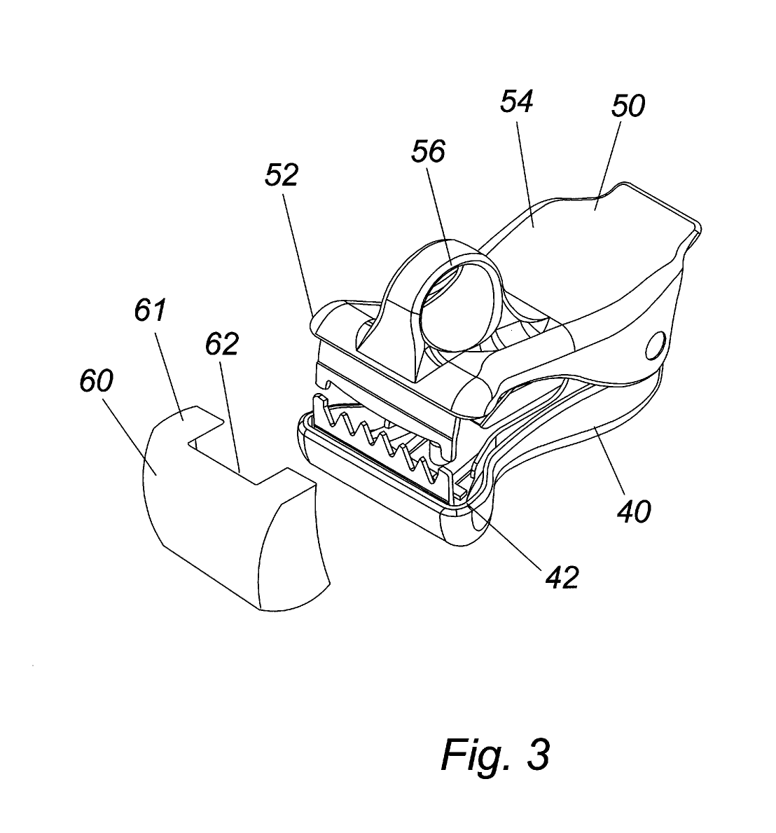

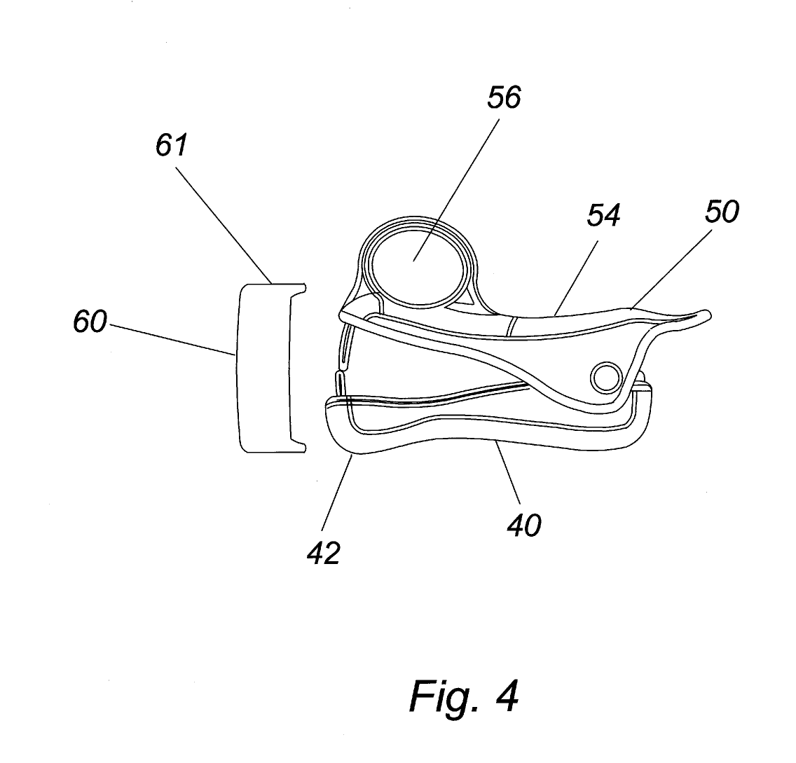

As shown in FIGS. 3 and 4, in a fully compressed state wherein the distal ends (42 and 52) overlap thereby allowing the cutting elements to operate for removal of the hair. The biasing springs (41 and 43) are constructed and arranged to provide a “chomp” feel during the closing of the arms which can be used as an auditory sound for the complete closing of the blades during the cutting action.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A hair clipper comprising:
a first arm having a distal end and a proximal end;
a second arm having a distal end and a proximal end, wherein said proximal ends of said first and second arms are connected;
a first cutting element positioned along said distal end of said first arm;
a second cutting element positioned along said distal end of said second arm; wherein said first and second cutting elements cooperate with each other to clip hair when said distal ends are pivoted into a closed position;
a first hair alignment cover element positioned from said distal end to said proximal end of said first arm; and
a second hair alignment cover element positioned from said distal end to said proximal end of said second arm, wherein said cutting elements and said hair alignment cover elements cooperate with each other to position strands of hair perpendicular to said cutting elements when said distal ends are pivoted into a closed position.

2. The hair clipper according to claim 1 including connected spring mounts along an inner surface of said first arm and said second arm for biasing said distal ends in an open position.

3. The hair clipper according to claim 1 wherein said first cutting element alignment element includes a plurality of teeth sized to capture strands of hair for ease of trimming.

4. The hair clipper according to claim 1 wherein said first cutting element alignment element includes a spring mounted along an inner surface of said first arm and said second arm for biasing said distal ends in an open position.

5. The hair clipper according to claim 1 wherein said cutting elements are serrated.

6. The hair clipper according to claim 1 wherein said first cutting element includes a spacer element for positional closure of said distal ends.

7. The hair clipper according to claim 1 wherein an outer surface of each said alignment element forms an ergonomic gripping surface.

8. The hair clipper according to claim 1 wherein a cutting edge cover constructed and arranged to frictionally engage said first and second hair alignment cover element on said distal end to provide safety from said first and second cutting elements.
